(19) United States
(12) Patent Application Publication
(10) Pub. No.: US 2013/0013670 A1
(43) Pub. Date: Jan. 10, 2013

(54) APPARATUS AND METHOD FOR PROVIDING USER INTERFACE

(75) Inventor: Byung-Soo Lim, Yongin-si (KR)

(73) Assignee: SAMSUNG ELECTRONICS CO., LTD., Suwon-si (KR)

(21) Appl. No.: 13/543,654

(22) Filed: Jul. 6, 2012

(30) Foreign Application Priority Data
Jul. 6, 2011 (KR) 10-2011-0067006

(51) Int. Cl. G06F 15/16

(52) U.S. Cl. 709/203

(57) ABSTRACT

An apparatus and method for configuring a remote user interface of an application represented in a structured format. A method for configuring a remote user interface (RUI) of an application represented in a structured format in a RUT server includes transmitting RUI configuration information to a RUT client upon an occurrence of an initial setup event. The method also includes transmitting RUI change information to the RUI client upon an occurrence of a RUT change event, wherein the RUI configuration information includes type information mapped to a configuration of the remote user interface, and the RUT change information includes type information mapped to a changed configuration of the remote user interface.

### CROSS-REFERENCE TO RELATED APPLICATION(S) AND CLAIM OF PRIORITY

The present application is related to and claims priority under 35 U.S.C. §119 to an application filed in the Korean Intellectual Property Office on Jul. 6, 2011 and assigned Serial No. 10-2011-0067006, the contents of which are incorporated herein by reference.

### TECHNICAL FIELD OF THE INVENTION

The present disclosure relates generally to an apparatus and method for providing a user interface (UI), and in particular, to an apparatus and method for providing a remote UI (RUI) for remote control.

### BACKGROUND OF THE INVENTION

A remote UI (RUI) is provided from a RUI server (hereinafter also referred to as a UI server) to a RUI client (hereinafter also referred to as a UI client) to display an interface for a service, provided by the UI server, in the UI client. For example, if a home network using a remote UI includes a digital TV, a refrigerator, a set top box, and an audio system, a user may control other devices through the digital TV. The other devices controlled through the digital TV may provide their own UI to the digital TV for the convenience of the user. The user may control the other devices by means of a user UI displayed on the screen of the digital TV.

As described above, the UI server transmits its own UI to the UI client for remote control of the UI client. The UI server uses the environment and characteristic information of the UI client to configure a user interface to be transmitted to the UI client.

However, the UI server may be required to prestore UI information to be transmitted to the UI client that uses a service provided by the UI server itself. Also, the UI server may use the environment and characteristic information of the UI client to separately configure a remote UI to be used in the UI client, thus causing an overhead of the UI server.

### SUMMARY OF THE INVENTION

To address the above-discussed deficiencies of the prior art, it is a primary object to provide at least the advantages below. Accordingly, an object of the present disclosure is to provide an apparatus and method for configuring a remote UI (RUI).

Another object of the present disclosure is to provide an apparatus and method for configuring a remote UI for remotely controlling an application represented in a structured document, such as a widget.

Another object of the present disclosure is to provide an apparatus and method for transmitting UI configuration information for configuring a remote UI in an RUI server.

Another object of the present disclosure is to provide an apparatus and method for transmitting UI change information in a RUI server.

Another object of the present disclosure is to provide an apparatus and method for configuring a remote UI by means of UI configuration information in a RUI client.

Another object of the present disclosure is to provide an apparatus and method for reconfiguring a remote UI by means of UI change information in a RUI client.

According to an aspect of the present disclosure, a method for configuring a remote user interface (RUT) of an application represented in a structured format in an RUI server includes transmitting RUI configuration information to a RUI client upon an occurrence of an initial setup event. The method also includes transmitting RUI change information to the RUI client upon an occurrence of an RUI change event, wherein the RUI configuration information includes type information mapped to a configuration of the remote user interface, and the RUI change information includes type information mapped to a changed configuration of the remote user interface.

According to another aspect of the present disclosure, a method for configuring a remote user interface (RUI) of an application represented in a structured format in a RUI client includes configuring a remote user interface by means of RUI configuration information upon an occurrence of an initial setup event. The method also includes reconfiguring, when receiving RUI change information from a RUI server, the remote user interface by means of the RUI change information, wherein the RUI configuration information includes type information mapped to a configuration of the remote user interface, and the RUI change information includes type information mapped to a changed configuration of the remote user interface.

According to another aspect of the present disclosure, an apparatus for configuring a remote user interface (RUI) of an application represented in a structured format in a RUI server includes a controlling module configured to generate RUI configuration information upon an occurrence of an initial setup event and generate RUI change information upon an occurrence of an RUI change event. The apparatus also includes a transmitting/receiving module configured to transmit the generated RUI configuration information and the generated RUI change information to an RUI client, wherein the RUI configuration information includes type information mapped to a configuration of the remote user interface, and the RUI change information includes type information mapped to a changed configuration of the remote user interface.

According to another aspect of the present disclosure, an apparatus for configuring a remote user interface (RUI) of an application represented in a structured format in an RUI client includes a transmitting/receiving module configured to transmit and receive signals to and from a RUI server. The apparatus also includes a RUI configuring module configured to configure a remote user interface by means of RUI configuration information upon an occurrence of an initial setup event, and reconfigure, when receiving RUI change information through the transmitting/receiving module, the remote user interface by means of the RUI change information, wherein the RUI configuration information includes type information mapped to a configuration of the remote user interface, and the RUI change information includes type information mapped to a changed configuration of the remote user interface.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrate a process for configuring a remote user interface (RUI) according to an embodiment of the present disclosure;

FIG. 2 illustrate a process for configuring a remote user interface (RUI) according to another embodiment of the present disclosure;

FIGS. 3A and 3B illustrate a document object model (DOM) of a remote user interface (RUI) according to an embodiment of the present disclosure;

FIGS. 4A through 4D illustrate a configuration screen of a remote user interface (RUI) according to an embodiment of the present disclosure;

FIG. 5 is a block diagram of a remote user interface (RUI) server according to an embodiment of the present disclosure; and

FIG. 6 is a block diagram of a remote user interface (RUI) client according to an embodiment of the present disclosure.

### DETAILED DESCRIPTION OF THE INVENTION

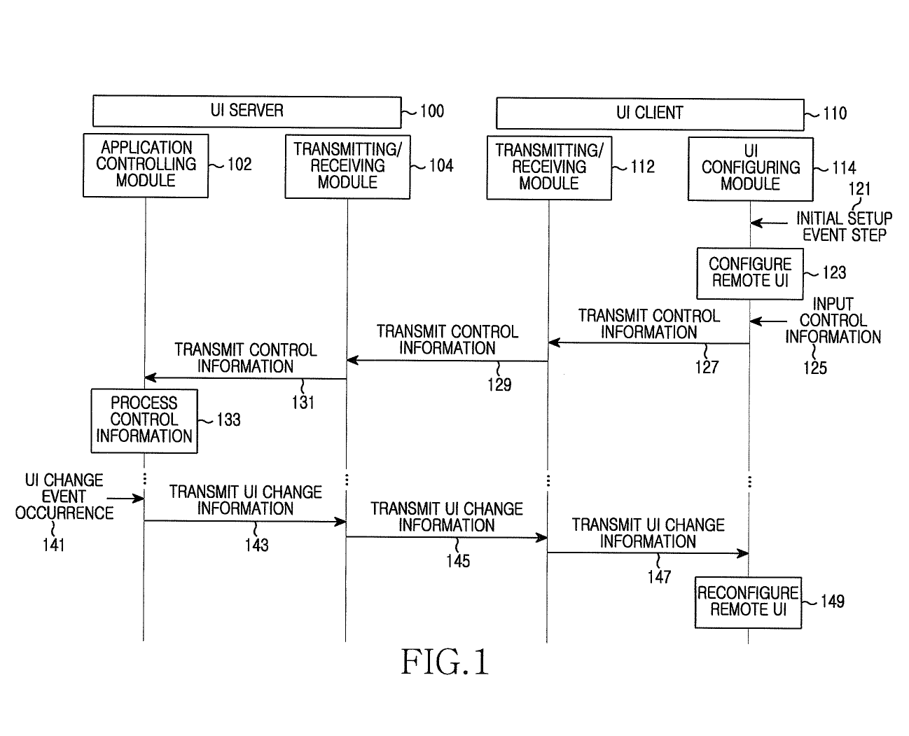

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless system. Embodiments of the present disclosure will be described herein below with reference to the accompanying drawings.

Exemplary embodiments of the present disclosure will be described herein below with reference to the accompanying drawings. In the following description, detailed descriptions of well-known functions or configurations will be omitted since they would unnecessarily obscure the subject matters of the present disclosure. Also, the terms used herein are defined according to the functions of the present disclosure. Thus, the terms may vary depending on users' or operators' intentions or practices. Therefore, the terms used herein are to be understood based on the descriptions made herein.

The present disclosure provides a scheme for configuring a remote user interface (RUI).

The following description is made on the assumption of configuring a remote user interface of an application represented in a structured format, such as a widget.

FIG. 1 is a flow diagram illustrating a process for configuring a remote user interface (RUI) according to an embodiment of the present disclosure.

Referring to FIG. 1, a RUI server (hereinafter also referred to as UI server) 100 includes an application controlling module 102 and a transmitting/receiving module 104. A RUI client ((hereinafter also referred to as UI client) 110 includes a transmitting/receiving module 112 and a UI configuring module 114.

The UI client 110 includes basis information for configuring a remote user interface. Accordingly, when an initial setup event occurs (operation 121), the UI configuring module 114 uses the basic information to configure a remote user interface for controlling an application of the UI server 100 (operation 123). For example, when connecting with the UI server 100 in order to use a service provided by the UI server 100, the UI client 110 determines that the initial setup event has occurred. As another example, when receiving setup instruction information from the UI server 100, the UI client 110 determines that the initial setup event has occurred. When executing an application, the UI server 100 transmits the setup instruction information to the UI client 110 in order to enable a user to control the application through the UI client 110.

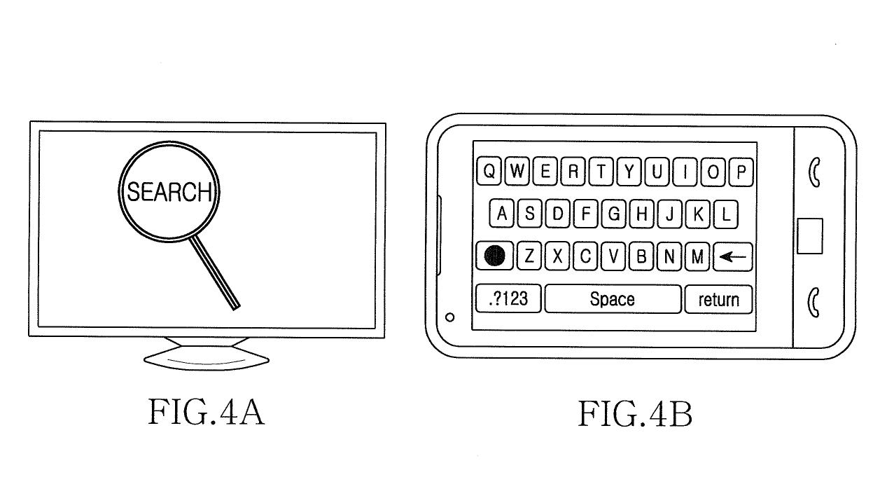

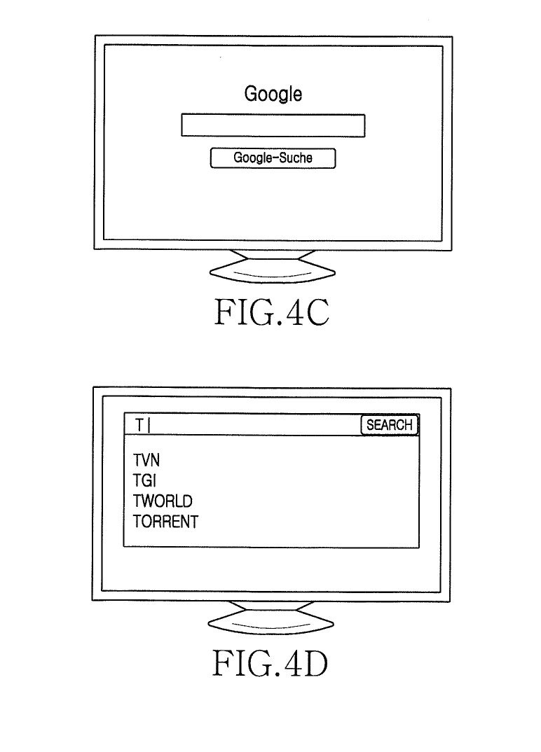

The UI client 110 displays the remote user interface on a display unit in order to enable the user to detect the remote user interface. For example, the UI configuring module 114 displays a QWERTY keyboard on a screen as illustrated in FIG. 4B.

When the user inputs control information through the remote user interface displayed on the display unit (operation 125), the UI configuring module 114 transmits the control information through the transmitting/receiving module 112 to the UI server 100 (operation 127 and operation 129). For example, when the user inputs search information through the QWERTY keyboard as illustrated in FIG. 4B, the UI configuring module 114 transmits the search information through the transmitting/receiving module 112 to the UI server 100.

The transmitting/receiving module 104 of the UI server 100 transmits the control information, received from the transmitting/receiving module 112 of the UI client 110, to the application controlling module 102 (operation 131).

The application controlling module 102 processes the control information received from the transmitting/receiving module 104 (operation 133). For example, when receiving the search information from the UI client 110 during the execution of a search application as illustrated in FIG. 4C, the application controlling module 102 searches for the received search information as illustrated in FIG. 4D.

When a UI change event occurs (operation 141), the application controlling module 102 transmits RUI change information through the transmitting/receiving module 104 to the UI client 110 (operation 143 and operation 145). For example, when a screen of a widget is switched in the DOM level 2 standard, a mutation event occurs. In this situation, the application controlling module 102 recognizes the occurrence of the mutation event as the occurrence of the UI change event. Upon an occurrence of the UI change event, the application controlling module 102 transmits changed form object information through the transmitting/receiving module 104 to the UI client 110. The changed form object information includes type information of a changed form object.

The transmitting/receiving module 112 of the UI client 110 transmits the changed form object information, received from the transmitting/receiving module 104 of the UI server 100, to the UI configuring module 114 (operation 147).

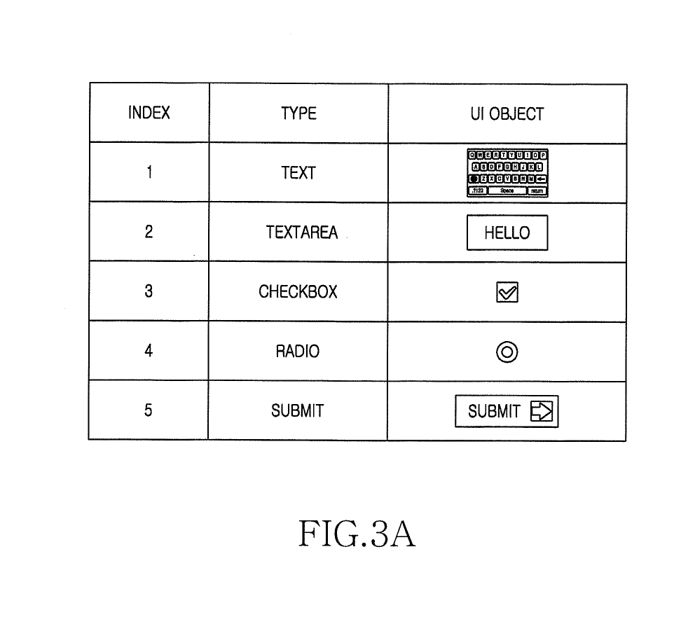

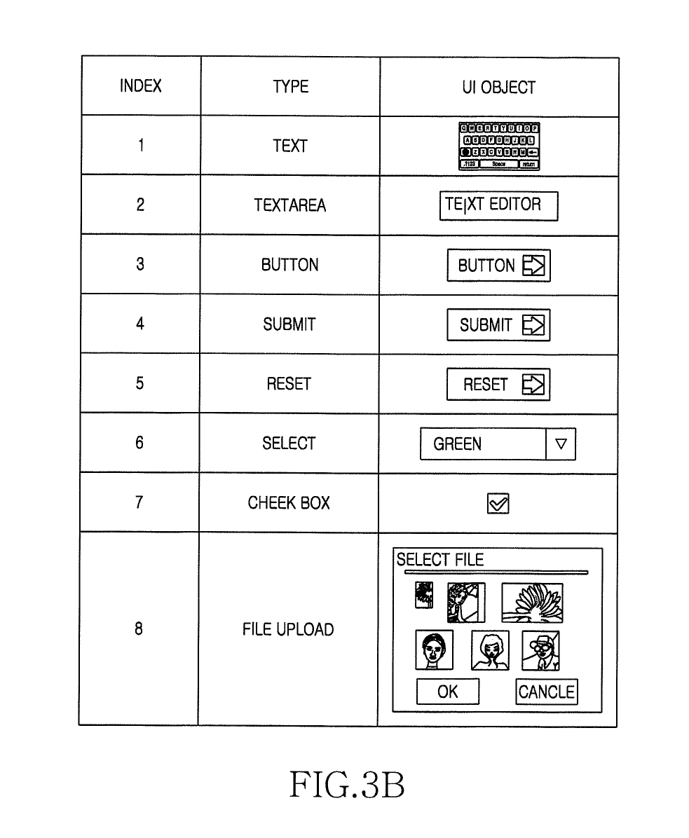

The UI configuring module 114 reconfigures the remote user interface according to the changed form object information (operation 149). For example, the UI configuring module 114 includes mapping information of an UI object as illustrated in FIGS. 3A and 3B. Accordingly, the UI configuring module 114 extracts a UI configuration (object), which corresponds to the type information of the changed form object received from the UI server 100, from the mapping information of an UI object illustrated in FIGS. 3A and 3B. Thereafter, the UI configuring module 114 uses the extracted UI configuration to reconfigure the remote user interface.

In the above embodiment, the UI client 110 includes basis information for configuring the remote user interface. Accordingly, the UI client 110 uses the basis information to configure the remote user interface.

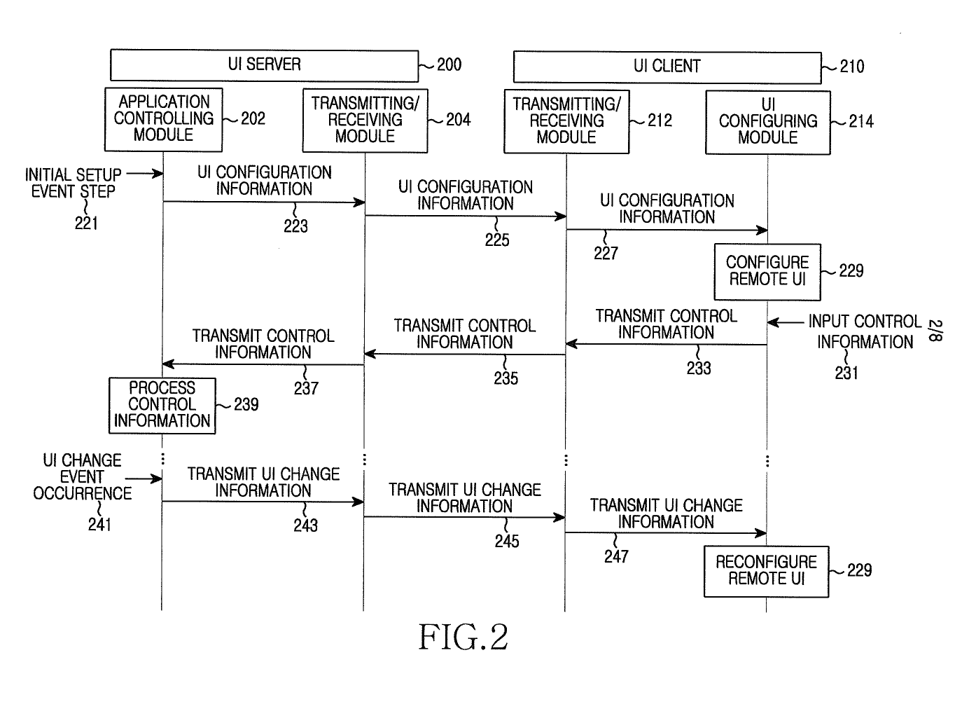

In another embodiment, the UI client 110 may not include the basis information for configuring the remote user interface. In this situation, the UI client 110 may configure the remote user interface as illustrated in FIG. 2.

FIG. 2 is a flow diagram illustrating a process for configuring a remote user interface (RUI) according to another embodiment of the present disclosure.

Referring to FIG. 2, a UI server 200 includes an application controlling module 202 and a transmitting/receiving module 204. A UI client 210 includes a transmitting/receiving module 212 and a UI configuring module 214.

When an initial setup event occurs (operation 221), the application controlling module 202 of the UI server 200 transmits form object information, which is used to configure a remote user interface, through the transmitting/receiving module 204 to the UI client 210 (operation 223 and operation 225). For example, when a search program is executed as illustrated in FIG. 4A, the application controlling module 202 determines that the initial setup event has occurred. The application includes a form object for processing a user input or the like. Accordingly, the application controlling module 202 transmits form object information of the application through the transmitting/receiving module 204 to the UI client 210. The form object information includes type information of a changed form object. For example, when a search program is executed as illustrated in FIG. 4A, the application controlling module 202 transmits text type information through the transmitting/receiving module 204 to the UI client 210 in order to enable a user to input search information through the UI client 210.

The transmitting/receiving module 212 of the UI client 210 transmits the form object information, received from the transmitting/receiving module 204 of the UI server 200, to the UI configuring module 214 (operation 227).

The UI configuring module 214 uses the form object information to configure a remote user interface (operation 229). For example, the UI configuring module 214 includes mapping information of an UI object as illustrated in FIGS. 3A and 3B. Accordingly, the UI configuring module 214 extracts a UI configuration (object), which corresponds to the type information of the form object received form the UI server 200, from the mapping information of an UI object illustrated in FIGS. 3A and 3B. Thereafter, the UI configuring module 214 uses the extracted UI configuration to reconfigure the remote user interface.

The UI client 210 displays the remote user interface on a display unit in order to enable the user to detect the same. For example, when the UI server 200 transmits text &um object information, the UI configuring module 214 displays a QWERTY keyboard on a screen according to the mapping information of FIGS. 3A and 3B as illustrated in FIG. 4B.

When the user inputs control information through the remote user interface displayed on the display unit (operation 231), the UI configuring module 214 transmits the control information through the transmitting/receiving module 212 to the UI server 200 (operation 233 and operation 235). For example, when the user inputs search information through the QWERTY keyboard as illustrated in FIG. 4B, the UI configuring module 214 transmits the search information through the transmitting/receiving module 212 to the UI server 200.

The transmitting/receiving module 204 of the UI server 200 transmits the control information, received from the transmitting/receiving module 212 of the UI client 210, to the application controlling module 202 (operation 237).

The application controlling module 202 processes the control information received from the transmitting/receiving module 204 (operation 239). For example, when receiving the search information from the UI client 210 during the execution of a search application as illustrated in FIG. 4C, the application controlling module 202 searches for the received search information as illustrated in FIG. 4D.

When a UI change event occurs (operation 241), the application controlling module 202 transmits RUI change information through the transmitting/receiving module 204 to the UI client 210 (operation 243 and operation 245). For example, when a screen of a widget is switched in the DOM level 2 standard, a mutation event occurs. Accordingly, the application controlling module 202 recognizes the occurrence of the mutation event as the occurrence of the UI change event. In this situation, the application controlling module 202 transmits changed form object information through the transmitting/receiving module 204 to the UI client 210. The changed form object information includes type information of a changed form object.

The transmitting/receiving module 212 of the UI client 210 transmits the changed form object information, received from the transmitting/receiving module 204 of the UI server 200, to the UI configuring module 214 (operation 247).

The UI configuring module 214 reconfigures the remote user interface according to the changed form object information (operation 249). For example, the UI configuring module 214 includes mapping information of an UI object as illustrated in FIGS. 3A and 3B. Accordingly, the UI configuring module 214 extracts a UI configuration (object), which corresponds to the type information of the changed form object received form the UI server 200, from the mapping information of an UI object illustrated in FIGS. 3A and 3B. Thereafter, the UI configuring module 214 uses the extracted UI configuration to reconfigure the remote user interface.

A configuration of the UI server will be described below in detail.

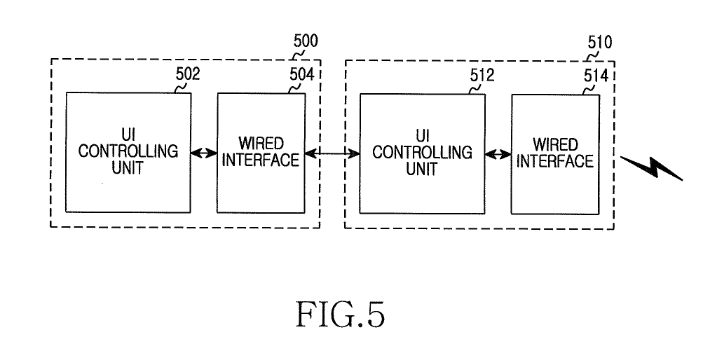

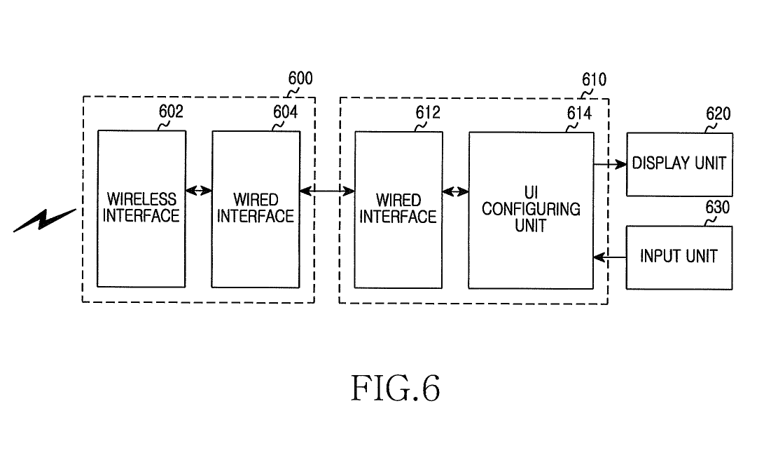

FIG. 5 is a block diagram of a remote user interface (RUI) server according to an embodiment of the present disclosure.

Referring to FIG. 5, the UI server includes an application controlling module 500 and a transmitting/receiving module 510.

The application controlling module 500 includes a UI controlling unit 502 and a wired interface 504. The transmitting/receiving module 510 includes a wired interface 512 and a wireless interface 514.

The UI controlling unit 502 controls an overall operation of the application controlling module 500. For example, the UI controlling unit 502 controls the execution of an application for providing a service. In an embodiment, the UI controlling unit 502 determines that an initial setup event has occurred. Accordingly, the UI controlling unit 502 transmits setup instruction information to the wired interface 504 to instruct the configuration of a remote user interface for enabling a user to control the application through the UI client. As another example, when an initial setup event occurs, the UI controlling unit 502 transmits form object information of the application to the wired interface 504 in order to configure a remote user interface for enabling the user to control the application through the UI client.

The UI controlling unit 502 processes control information received from the wired interface 504.

When a UI change event occurs, the UI controlling unit 502 transmits RUI change information to the wired interface 504. For example, when a screen of a widget is switched in the DOM level 2 standard, a mutation event occurs. In this situation, the UI controlling unit 502 recognizes the occurrence of the mutation event as the occurrence of the UI change event. Accordingly, the UI controlling unit 502 transmits changed form object information to the wired interface 504. The changed form object information includes type information of a changed form object.

The UI controlling unit 502 controls the installation of an application to be executed in the UI server. For example, when the UI server uses a plurality of applications, the UI controlling unit 502 performs a control operation for configuring a remote user interface of each of the applications. That is, when a new application is installed in the UI server, the UI server updates the application controlling module 500 to include the new application. In this situation, as illustrated in FIG. 1 or FIG. 2, the UI controlling unit 502 performs a control operation for configuring a remote user interface of the new application.

The wired interface 504 connects with the wired interface 512 of the transmitting/receiving module 510 to transmit/receive signals between the application controlling module 500 and the transmitting/receiving module 510. For example, the wired interface 504 transmits the form object information of the application or the setup instruction information, received from the UI controlling unit 502, to the wired interface 512 of the transmitting/receiving module 510. As another example, the wired interface 504 provides the control information, received from the wired interface 512 of the transmitting/receiving module 510, to the UI controlling unit 502. As another example, the wired interface 504 transmits the RUI change information, received from the UI controlling unit 502, to the wired interface 512 of the transmitting/receiving module 510.

The wired interface 512 connects with the wired interface 504 of the application controlling module 500 to transmit/receive signals between the application controlling module 500 and the transmitting/receiving module 510. For example, the wired interface 512 transmits the form object information of the application or the setup instruction information, received from the wired interface 504 of the application controlling module 500, to the wireless interface 514. As another example, the wired interface 512 provides the control information, received from the wireless interface 514, to the wired interface 504 of the application controlling module 500. As another example, the wired interface 512 transmits the RUI change information, received from the wired interface 504 of the application controlling module 500, to the wireless interface 514.

The wireless interface 514 uses wireless resources to communicate signals with the UI client. For example, the wireless interface 514 transmits the form object information of the application or the setup instruction information, received from the wired interface 512, to the UI client. As another example, the wireless interface 514 provides the control information, received from the UI client, to the wired interface 512. As another example, the wireless interface 514 transmits the UI change information, received from the wired interface 512, to the UI client. Herein, the wireless interface 514 communicates signals with the UI client by means of any one of Hyper Text Transfer Protocol (HTTP) transmission, Internet Control Message Protocol (ICMP) transmission, and User Datagram Protocol (UDP) transmission.

FIG. 6 is a block diagram of a remote user interface (RUI) client according to an embodiment of the present disclosure.

Referring to FIG. 6, the UI client may include a transmitting/receiving module 600, a UI configuring module 610, a display unit 620, and an input unit 630.

The transmitting/receiving module 600 includes a wireless interface 602 and a wired interface 604. The UI configuring module 610 includes a wired interface 612 and a UI configuring unit 614.

The wireless interface 602 uses wireless resources to communicate signals with the UI server. For example, the wireless interface 602 transmits the RUI setup instruction information received from the UI server or the form object information of the application executed in the UI server, to the wired interface 604. As another example, the wireless interface 602 provides the control information, received from the wired interface 604, to the UI server. As another example, the wireless interface 602 transmits the UI change information, received from the UI server, to the wired interface 604. Herein, the wireless interface 602 communicates signals with the UI client by means of any one of HTTP transmission, ICMP transmission, and UDP transmission.

The wired interface 604 connects with the wired interface 612 of the UI configuring module 610 to transmit/receive signals between the UI configuring module 610 and the transmitting/receiving module 600. For example, the wired interface 604 transmits the RUI setup instruction information received from the wireless interface 602 or the form object information of the application executed in the UI server, to the wired interface 612 of the UI configuring module 610. As another example, the wired interface 604 provides the control information, received from the wired interface 612 of the UI configuring module 610, to the wireless interface 602. As another example, the wired interface 604 transmits the RUI change information, received from the wired interface 612 of the UI configuring module 610, to the wired interface 612 of the UI configuring module 610.

The wired interface 612 connects with the wired interface 604 of the transmitting/receiving module 600 to transmit/receive signals between the UI configuring module 610 and the transmitting/receiving module 600. For example, the wired interface 612 transmits the RUI setup instruction information received from the wired interface 604 or the form object information of the application executed in the UI server, to the UI configuring unit 614. As another example, the wired interface 612 provides the control information, received from the UI configuring unit 614, to the wired interface 604 of the transmitting/receiving module 600. As another example, the wired interface 612 transmits the RUI change information, received from the wired interface 604 of the transmitting/receiving module 600, to the UI configuring unit 614.

The UI configuring unit 614 configures a remote user interface for remotely controlling an application of the UI server. For example, when an initial setup event occurs, the UI configuring unit 614 uses preset basic information to configure a remote user interface for controlling an application of the UI server. As another example, the UI configuring unit 614 configures a remote user interface for controlling an application of the UI server, by using form object information for RUI configuration received from the wired interface 612. As another example, the UI configuring unit 614 displays the remote user interface on the display unit 620 in order to enable the user to detect the same. If receiving text form object information from the UI server, the UI configuring unit 614 displays a QWERTY keyboard on the display unit 620 according to the mapping information of FIGS. 3A and 3B, as illustrated in FIG. 4B. As another example, the UI configuring unit 614 transmits the control information of the user, received through the input unit 630, to the wired interface 612. As another example, the UI configuring unit 614 reconfigures a remote user interface for controlling an application of the UI server, by using the form object information for RUI configuration received form the wired interface 612.

Although not illustrated, the UI configuring module 610 further includes a storing unit that stores basic information for configuring a remote user interface.

In the above embodiment, the transmitting/receiving module 600 and the UI configuring module 610 of the UI client are separated from each other.

In another embodiment, the transmitting/receiving module 600 and the UI configuring module 610 of the UI client may be integrated into one module.

As described above, the RUI client configures a remote UI according to UI configuration information received from the RUI server, thereby making it possible to reduce the overhead of the RUI server according to RUI configuration.

Also, the RUI client reconfigures a remote UI according to UI change information received from the RUI server, thereby making it possible to dynamically configure a remote UI.

While the disclosure has been shown and described with reference to certain exemplary embodiments thereof, it will be understood by those skilled in the art that various changes in form and details may be made therein without departing from the spirit and scope of the disclosure as defined by the appended claims. Therefore, the scope of the disclosure is defined not by the detailed description of the disclosure but by the appended claims, and all differences within the scope will be construed as being included in the present disclosure.

What is claimed is:

1. A method for configuring a remote user interface (RUI) of an application represented in a structured format in a RUI server, comprising:
transmitting RUI configuration information to a RUI client upon an occurrence of an initial setup event; and
transmitting RUI change information to the RUI client upon an occurrence of an RUI change event,
wherein the RUI configuration information includes type information mapped to a configuration of the remote user interface, and the RUI change information includes type information mapped to a changed configuration of the remote user interface.

2. The method of claim 1, wherein the RUI server comprises:
a controlling module configured to generate RUI configuration information upon the occurrence of the initial setup event and generate RUI change information upon the occurrence of the RUI change event; and
a transmitting/receiving module configured to transmit the generated RUI configuration information and the generated RUI change information to the RUI client.

3. The method of claim 2, further comprising, upon an installation of a new application, updating the controlling module to include information associated with the new application.

4. The method of claim 2, wherein the transmitting/receiving module transmits and receives signals to and from the RUI client by any one of HTTP transmission, ICMP transmission, and UDP transmission.

5. The method of claim 1, further comprising determining whether the application is executed,
wherein an initial setup event is determined to have occurred, when the application is executed.

6. The method of claim 1, further comprising determining whether a screen of the application is switched, after transmitting the RUI configuration information to the RUI client,
wherein an RUI change event is determined to have occurred, when the screen of the application is switched.

7. A method for configuring a remote user interface (RUI) of an application represented in a structured format in a RUI client, comprising:
configuring a remote user interface by means of RUI configuration information upon an occurrence of an initial setup event; and
reconfiguring, when receiving RUI change information from a RUI server, the remote user interface by means of the RUI change information,
wherein the RUI configuration information includes type information mapped to a configuration of the remote user interface, and the RUI change information includes type information mapped to a changed configuration of the remote user interface.

8. The method of claim 7, wherein configuring the remote user interface comprises:
receiving RUI configuration information from the RUI server;
detecting configuration information mapped to type information included in the RUI configuration information, from a mapping table; and
configuring the remote user interface by means of the configuration information.

9. The method of claim 7, wherein reconfiguring the remote user interface comprises:
receiving RUI change information from the RUI server;
detecting configuration information mapped to type information included in the RUI change information, from a mapping table; and
reconfiguring the remote user interface by means of the configuration information.

10. The method of claim 7, further comprising:
displaying the remote user interface on a display unit after configuring the remote user interface; and
transmitting the control information to the RUI server when receiving control information through the remote user interface.

11. An apparatus for configuring a remote user interface (RUI) of an application represented in a structured format in a RUI server, comprising:
a controlling module configured to generate RUI configuration information upon an occurrence of an initial setup event and generate RUI change information upon an occurrence of an RUI change event; and
a transmitting/receiving module configured to transmit the generated RUI configuration information and the generated RUI change information to an RUI client,
wherein the RUI configuration information includes type information mapped to a configuration of the remote user interface, and the RUI change information includes type information mapped to a changed configuration of the remote user interface.

12. The apparatus of claim 11, wherein upon an installation of a new application, the controlling module is updated to include information associated with the new application.

13. The apparatus of claim 11, wherein the transmitting/receiving module transmits and receives signals to and from the RUT client by any one of HTTP transmission, ICMP transmission, and UDP transmission.

14. The apparatus of claim 11, wherein when the application is executed, the controlling module is configured to determine that an initial setup event has occurred.

15. The apparatus of claim 11, wherein when a screen of the application is switched, the controlling module is configured to determine that a RUI change event has occurred.

16. An apparatus for configuring a remote user interface (RUI) of an application represented in a structured format in an RUI client, comprising:
a transmitting/receiving module configured to transmit and receive signals to and from a RUT server; and
a RUI configuring module configured to configure a remote user interface by means of RUT configuration information upon an occurrence of an initial setup event, and reconfigure, when receiving RUI change information through the transmitting/receiving module, the remote user interface by means of the RUI change information,
wherein the RUI configuration information includes type information mapped to a configuration of the remote user interface, and the RUI change information includes type information mapped to a changed configuration of the remote user interface.

17. The apparatus of claim 16, further comprising a storing unit configured to store RUI configuration information and a mapping table,
wherein the RUI configuring module is configured to detect configuration information mapped to type information included in the RUI configuration information, from the mapping table, and configure the remote user interface by means of the configuration information.

18. The apparatus of claim 16, wherein the RUI configuring module is configured to detect configuration information mapped to type information included in RUI configuration information received through the transmitting/receiving module, from a mapping table, and configure the remote user interface by means of the configuration information.

19. The apparatus of claim 16, wherein the RUI configuring module is configured to detect configuration information mapped to type information included in the RUI change information received through the transmitting/receiving module, from a mapping table, and reconfigure the remote user interface by means of the configuration information.

20. The apparatus of claim 16, further comprising a display unit configured to display the remote user interface,
wherein when receiving control information through the displayed remote user interface, the RUI configuring module is configured to transmit the control information to the RUI server.
